(19) United States
(12) Patent Application Publication
(10) Pub. No.: US 2006/0039439 A1
(43) Pub. Date: Feb. 23, 2006

(54) Total internal reflecting laser pump cavity

(76) Inventors: John E. Nettleton, Fairfax Station, VA (US); Dallas N. Barr, Woodbridge, VA (US)

Correspondence Address: DEPARTMENT OF THE ARMY, AMSEL LG P NVEO, 10225 BURBECK ROAD, FORT BELVOIR, VA, 22060-5806, US

(21) Appl. No.: 10/921,200

(22) Filed: Aug. 19, 2004

(51) Int. Cl. H01S 3/08

(52) U.S. Cl. 372/92

(57) ABSTRACT

A laser device in accordance with the present invention includes a diode pump for generating pump light and a pump cavity for receiving the pump light for conversion into an output laser beam. The pump cavity is formed as a trapezoidal prism, or a prism having bases with trapezoidal perimeters, rectangular sides, a rectangular input end and a rectangular output end. The trapezoidal prism has a decreasing taper, from a maximum width at the input end to a minimum width at the output end of the trapezoidal prism. The trapezoidal prism is formed by fixing a rectangular prism that is made of doped lasing material between two triangular prism portions that are made of undoped material. To facilitate ease of manufacture, a pallet is provided, and the diode pump and trapezoidal prism can be fixed to the pallet so that the diode pump is immediately proximate the input end of the trapezoidal prism.

### GOVERNMENT INTEREST

The invention described herein may be manufactured, used, sold, imported, and/or licensed by or for the Government of the United States of America.

### FIELD OF THE INVENTION

The present invention applies to devices for generating laser beams. More particularly, the present invention applies to laser generators that produce pulsed laser beams. The present invention is particularly, but not exclusively, useful as a device with a pump cavity that manipulates an input pump beam to yield a laser beam with greatly increased output power relative to similarly-sized devices with input pump beams of similar power.

### BACKGROUND OF THE INVENTION

The use of laser devices for rangefinding or target designation purposes is well known in the prior art. To be effective, these devices should have certain desirable qualities. Specifically, these devices should be small, lightweight and easy to manufacture. Additionally, the devices should produce a pulsed laser beam that has good output power and a high pulse repetition rate that are suitable for ranging and designation operations.

Previous laser transmitters used in rangefinding and designation have had some, but not all, of these characteristics. For example, some flashlamp-pumped solid-state laser devices have been used to generate a laser beam of sufficient power for these purposes. However, although flashlamp-pumped lasers effectively generate a single laser pulse, they are not capable of being pulsed at a high pulse repetition rate without adding cumbersome cooling systems, which increases the size and power requirements of the laser transmitter.

Diode-pumped solid-state lasers lead to more efficient pulsed lasing operation and therefore are suitable for rangefinding and designation purposes, but they tend to have a low output power. One way to increase the output power for diode-pumped solid-state lasers is to collimate the input pump light before the input pump light enters the laser crystal. To do this, however, an arrangement of collimation lenses is required, and the added weight is an undesirable characteristic for the rangefinding/designation type of laser. Further, the incorporation of collimation lenses creates significant optical alignment issues that complicate the assembly process for the laser.

It so happens that by altering the geometry of the laser crystal, the output power of a solid-state diode-pumped laser device can be increased without using a lens arrangement to collimate input pump light. This obviates the additional weight and assembly disadvantages that are inherent when collimation optics are used with a diode-pumped, solid-state laser device. Altering the geometry of the laser crystal can further decrease parasitic lasing within the cavity, which further results in greater lasing efficiency and greater output power for the laser device.

In view of the above, it is an object of the present invention to provide a diode-pumped laser device that can be used for rangefinding and designation purposes. It is another object of the present invention to provide a diode-pumped laser device which provides an output pulsed laser beam without requiring collimation optics for the pump. Another object of the present invention is to provide a diode-pumped laser device with a pump cavity having a predetermined geometry that further reduces parasitic laser modes within the pump cavity during operation thereof. Another object of the present invention is to provide a diode-pumped laser that is lightweight and battery-operated. Yet another object of the present invention is to design a laser which is easy to use and is comparatively cost-effective to manufacture.

### SUMMARY OF THE INVENTION

A laser device in accordance with the present invention includes a diode pump for generating pump light and a pump cavity for receiving the pump light and converting the pump light into an output laser beam. The pump cavity is formed as a trapezoidal prism, or a prism with trapezoidal bases, rectangular sides, a rectangular input end and a rectangular output end. The novel geometry of the pump cavity causes total internal reflection of the laser pump light and obviates the need for optics between the pump light source and pump cavity to collimate and re-direct the input pump light.

The trapezoidal prism further includes a rectangular prism of doped lasing material and at least one triangular prism that is made of undoped lasing material. The triangular prism is attached to the side of the rectangular prism to establish the aforementioned trapezoidal prism. Or, two triangular prisms can be fixed to opposing sides so that the rectangular prism portion is sandwiched between the triangular prism portions. In either case, the resulting configuration is a trapezoidal prism with a decreasing taper, from a maximum width at the input end to a minimum width at, or near, the output end of the trapezoidal prism. Preferably, the rectangular prism and triangular prism are selected from thermally compatible materials, or materials that have a uniform coefficient of thermal expansion.

To facilitate ease of manufacture, a pallet can be provided, and the diode pump and trapezoidal prism can be fixed to the pallet in optical alignment, so that the diode pump is immediately proximate the input end of the trapezoidal prism. For eyesafe applications, an optical parametric oscillator (OPO) can be fixed to the pallet proximate the output end of the pump cavity.

### BRIEF DESCRIPTION OF THE DRAWINGS

The novel features of this invention will be best understood from the accompanying drawings, taken in conjunction with the accompanying description, in which similar characters refer to similar parts, and in which:

FIG. 1 is a top plan view of the laser of the present invention.

FIG. 2 is a top plan view of the pump cavity and pump light source components of the laser of FIG. 1.

FIG. 3 is an isometric view of the pump cavity of FIG. 2, with portions shown in phantom for enhanced clarity.

FIG. 4 is an isometric view of an alternative embodiment of the pump cavity shown in FIG. 3.

FIG. 5 is an isometric view of another alternative embodiment of the pump cavity shown in FIG. 3.

### WRITTEN DESCRIPTION OF THE PREFERRED EMBODIMENT

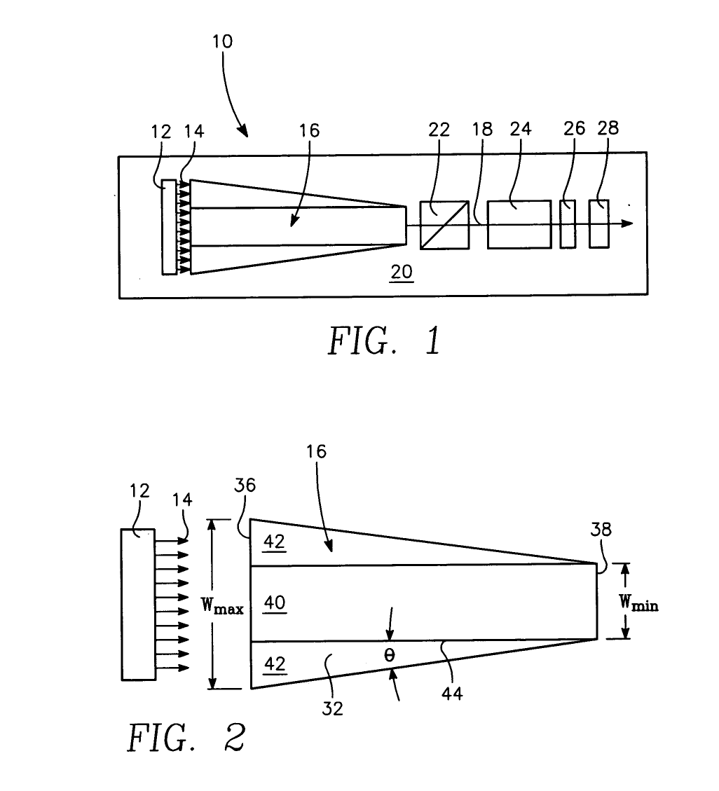

Referring initially to FIG. 1, the laser device of the present invention is shown and is generally designated by reference character 10. As shown, the device includes a pump light source 12 for generating input pump light (denoted by arrows 14). The laser pump light is received by a pump cavity 16, which converts the input pump light into an output laser light (represented by arrow 18). Both the pump light source and pump cavity are mounted to pallet 20 in immediate proximity to each other. The device further includes a polarizer 22, Q-switch 24, a quarter wave plate 26 and an output coupler (O.C.) 28, all of which are also mounted to the aforementioned pallet. In eyesafe laser applications, an optical parametric oscillator (OPO) is also attached to the pallet so that the output laser from O.C. 28 is converted into a different, desired wavelength.

The palletized nature of the device is important in that pump light source 12, pump cavity 16 and the other components mentioned above are mounted directly to the pallet, without requiring the use of optical holders. The manner in which this is accomplished is described more fully in U.S. patent application Ser. No. 6,373,865 by John E. Nettleton et al., entitled “Pseudo-Monolithic Laser With An Intracavity Optical Parametric Oscillator”, which is assigned to the same assignee as this patent application and which is incorporated herein by reference.

Referring now to FIGS. 2-5, the structure of the pump cavity is shown in greater detail. More specifically, the laser is formed as a trapezoidal prism. The trapezoidal prism has a bottom face 30 and a top face 32 which are approximately parallel, and the bottom face and top face have respective trapezoidal perimeters that are congruent. The trapezoidal prism is further formed with opposing rectangular side faces 34, 34. Additionally, the prism is formed with rectangular input end 36 and a rectangular output end 38 that are similar and approximately parallel. With this configuration, the pump cavity has a continuously decreasing taper (when viewed in top plan) from a maximum width wₘₐₓ at input end 36 to a minimum width wₘᵢₙ at output end 38 that is preferably about half of wₘₐₓ. Preferably, If pump light source 12 is a diode, the trapezoidal prism is preferably assembled as described above so that input end 36 has a width wₘₐₓ is about equal to the length of the laser diode.

The pump cavity comprises a plurality of portions that are fixed to each other. Specifically, the pump cavity comprises a rectangular prism portion 40 that is fixed between two opposing triangular prism portions 42, 42. As shown in the figures, the triangular prism portion has bases and top surfaces with respective perimeters 43a, 43b that have a congruent, right scalar triangular geometry.

The rectangular prism is made of a doped material, while the triangular prisms are made of an undoped material. For assembly, the triangular prism portions are permanently fixed to opposing sides of the rectangular prism with an optical bond, such as diffusion bonding so that there is no index mismatch after bonding. For this reason, the rectangular prism portion and triangular prism portions should be made of respective materials that are thermally compatible, in that they have the same thermal coefficient of expansion. The triangular prisms are fixed to the rectangular prism to yield the aforementioned trapezoidal prism.

In the preferred embodiment, the doped material used from the rectangular prism is a Neodymium doped Yttrium Aluminum Garnet (Nd:YAG) crystal that is doped to approximately one percent (1%), and the undoped material for the triangular prisms is a YAG material. However, it is understood that other materials could also be used for the doped rectangular prism portion, such as Neodymium Doped Yttrium Orthovanadate (Nd:YVO4), Neodymium Doped Yttrium Lithium Fluoride Nd:YLF and Neodymium Doped YAIO3 Perovskite (Nd:YAP) or doped glass materials. It is further understood that for the other doped materials mentioned (Nd:YVO4, Nd:YLF and Nd:YAP), for simplicity of batch manufacturing, the corresponding undoped YVO4, YLF or YAP material should be used for the triangular prism portion material. Finally, the input end 36 and output end 38 are coated with AR and HR coatings for diode laser pumping and lasing operations in a manner well known in the art.

When pump cavity 16 is configured as described above, input pump light from the pump light source 12 is reflected internally off the side faces 34, 34 of the trapezoidal prism (which is made of an undoped material) into the rectangular prism (which is made of a doped material). In this manner, total internal reflection of input pump light occurs within the trapezoidal prism, from the undoped triangular prism portions into the doped rectangular prism portion. To ensure that the reflection occurs, and to minimize parasitic lasing within the undoped triangular prism portions, side face of the trapezoidal prism makes a maximum angle θ with internal surface 44 of the rectangular prism portion when triangular prism portions are fixed thereto (See FIG. 3). The angle θ is normally set by the dimensions of the pump cavity length, width wₘₐₓ, and the width of the doped rectangular prism wₘᵢₙ. The angle θ is also set to assure that all pump photons are incident above the critical angle.

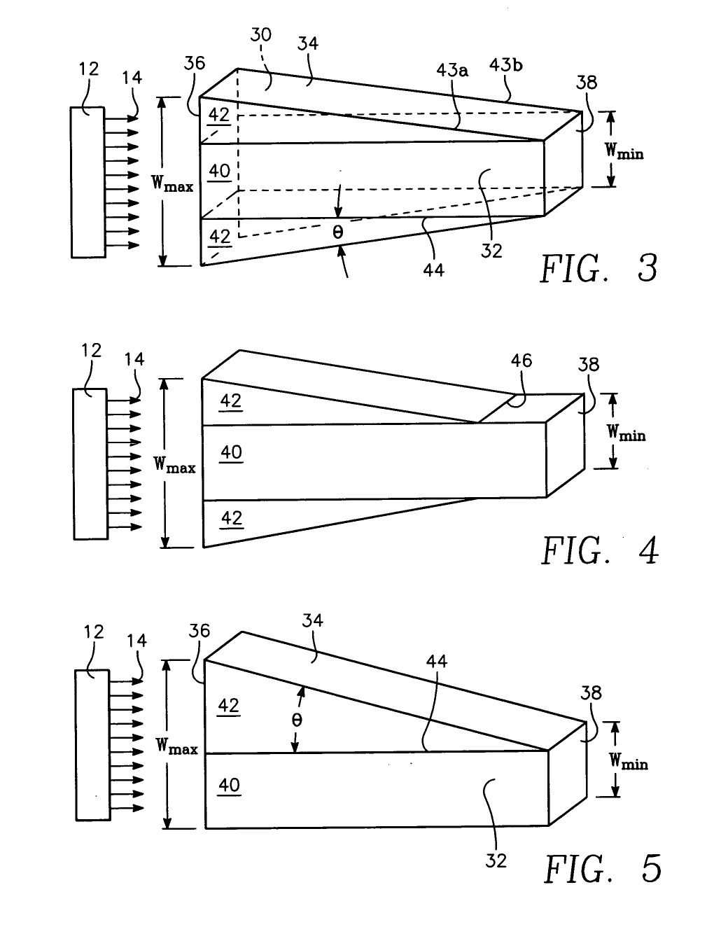

FIGS. 4 and 5 show alternate embodiments for the geometric configuration of the pump cavity. In FIG. 4, the triangular prism portion has a length that is shorter than the length of the rectangular prism portion. Thus, when the triangular prism portions are fixed to the rectangular prism portions as described above, the result is a trapezoidal prism with a continuously decreasing taper from a maximum width wₘₐₓ at input end 36 to a minimum width wₘᵢₙ at an intermediate point 46 along the pump cavity. The width then remains constant at wₘᵢₙ from intermediate point 46 to the output end 38 of the pump cavity.

In FIG. 5, there is only one triangular prism portion 42 that is fixed to a rectangular prism portion 40. This results in a trapezoidal prism with top and bottom faces that have a perimeter shaped as a scalene trapezoid, as opposed to the isosceles trapezoid perimeter of the top and bottom faces for the pump cavity shown in FIGS. 1-3 and described above. This configuration is actually easier to assemble, however, because only one optical bond is required for assembly of the pump cavity, and further results in decreased parasitic losses due to index mismatches at the rectangular prism portion/triangular prism portion interface (as there is only one interface, as opposed to two interfaces for the embodiment described above).

While the device, as herein shown and disclosed in detail, is fully capable of obtaining the objects and providing the advantages above stated, it is to be understood that the presently preferred embodiments are merely illustrative of the invention. As such, no limitations are intended other than as defined in the appended claims.

What is claimed is:

1. A laser device comprising:
a diode pump for generating laser pump light;
a pump cavity for receiving said pump light;
said pump cavity formed as a prism having trapezoidal bases and rectangular sides.

2. The device of claim 1 wherein said pump cavity has a rectangular input end and a rectangular output end that is parallel thereto.

3. The device of claim 2 wherein said trapezoidal base has a continuously decreasing taper from a maximum width at said input end to a minimum width at said output end.

4. The device of claim 2 wherein said trapezoidal base has a decreasing taper from a maximum width at said input end to a minimum width at an intermediate point, and then a constant minimum width from said intermediate point to said output end.

5. The device of claim 3 wherein said minimum width is about half of said maximum width.

6. The device of claim 1 wherein said prism has a rectangular prism portion that is made of a doped material that is sandwiched between two triangular prism portions that are made of an undoped material that has a uniform coefficient of thermal expansion with said doped material.

7. The device of claim 6 wherein said doped material is selected from a group consisting of Nd:YAG, Nd:YVO4, Nd:YLF and Nd:YAP.

8. The device of claim 1 wherein said trapezoidal base has an isosceles trapezoid perimeter.

9. A laser apparatus comprising:
a diode pump for generating laser pump light;
a rectangular prism made of a doped lasing material; and,
at least one triangular prism made of an undoped lasing material and fixed to said rectangular prism side, said triangular prism and said rectangular prism cooperating to establish a pump cavity for receiving said pump light and converting said pump light into an output laser beam.

10. The apparatus of claim 9 wherein said pump cavity has a rectangular input end and a rectangular output end that is parallel to said input end, and further wherein said pump cavity has a continuously decreasing taper from a maximum width at said input end to a minimum width at said output end.

11. The apparatus of claim 9 wherein said doped lasing material is selected from the group consisting of Nd:YAG, Nd:YVO4, Nd:YLF and Nd:YAP.

12. The apparatus of claim 10 wherein said minimum width is about half of said maximum width.

13. The device of claim 8 wherein said pump cavity defines a prism with trapezoidal bases and further comprising:
a pallet, said diode pump and said trapezoidal base of said pump cavity being fixed to said pallet; and,
an optical parametric oscillator (OPO) being attached to said pallet proximate said output end of said pump cavity for receiving said output laser beam.

14. A method for athermal lasing comprising the steps of:
A) generating laser pump light;
B) providing a first rectangular prism made of doped lasing material;
C) affording a second rectangular prism made an undoped lasing material;
D) splitting said second rectangular prism into two triangular prisms;
E) fixing at least one of said triangular prisms to said first rectangular prism to establish a trapezoidal prism with rectangular input end and a rectangular output end; and,
F) receiving said laser pump light at said rectangular input end.

15. The method of claim 14 wherein said step B) is accomplished with a material selected from the group consisting of Nd:YAG, Nd:YVO4, Nd:YLF and Nd:YAP.

16. The method of claim 15 wherein said step C) is accomplished with a material having a uniform thermal coefficient of expansion as the doped material of said step B).

17. The method of claim 14 wherein said step D) is accomplished to establish two triangular prisms with bases having a right scalene triangular perimeter.

18. The method of claim 17 wherein said step E) is accomplished by fixing both triangular prisms to said rectangular prism to establish a trapezoidal prism with bases having an isosceles trapezoid perimeter.

19. The method of claim 14 wherein said step A) is accomplished with a diode pump and further comprising the steps of:
G) furnishing a pallet; and
H) mounting said diode pump and said trapezoidal prism to said pallet so that said diode pump is immediately proximate said input end.
